(19) United States
(12) Patent Application Publication
(10) Pub. No.: US 2006/0125819 A1
(43) Pub. Date: Jun. 15, 2006

(54) Creating effects for images

(76) Inventor: Johannes Hakansson, Eslov (SE)

Correspondence Address: MYERS BIGEL SIBLEY & SAJOVEC, PO BOX 37428, RALEIGH, NC, 27627, US

(21) Appl. No.: 10/538,293

(22) PCT Filed: Dec. 5, 2003
(86) PCT No.: PCT/EP03/13765

§ 371 Date: Jun. 10, 2005

(30) Foreign Application Priority Data
Dec. 10, 2002 (EP) 020274528
Dec. 16, 2002 (US) 60433796

(51) Int. Cl. G06T 1/00; G06F 15/16; G09G 5/00

(52) U.S. Cl. 345/418; 345/644; 709/217

(57) ABSTRACT

Methods, local processing devices, image editors, and computer program products may provide storable image effects in a local processing device. A signal may be used to transport such image effects to other devices. The local processing device includes an image effects store and an image editor configured to generate a new effect for application on digital images based on entries of a user. The image editor may allow storing of said effect as an effects file in the image effects store. A user can personalise effects to be used on pictures that have been taken. Such effects may also be exchanged between different devices.

### TECHNICAL FIELD OF THE INVENTION

The present invention relates to the field of local processing devices and more particularly to the use of effects on images in local processing devices. In particular the present invention relates to a method for providing storable image effects in a local processing device, a local processing device, an image editor in a local processing device, a computer program product and a computer program element for providing storable image effects in a local processing device as well as a signal for transporting such image effects to other devices.

### DESCRIPTION OF RELATED ART

The cellular phones of today have more and more different functions and applications in them. It is today normal to provide the phones with a camera for taking pictures or provide a camera that can be connected to the phone while using the display as a view-finder. The cameras therefore also often have a photo editor application allowing different effects to be applied to captured images. These effects are pre-stored in the editor when assembling the camera in the factory.

It is in the field of cellular phones interesting to provide more and more diversified functions and applications to the user, so that they can use their phone to reflect their individual identity and personality. Thus there have been developed among other things shells that can be put on the phone, that have different types of designs as well as the possibility to download and create own ring signals. It would within the field of these devices therefore be interesting for a user to create his own effects for use on images, which he either captures himself or downloads or receives from others in order to mark his special identity onto such images.

A number of documents exist which describe the use of effects on pictures in a digital camera. For instance JP 11007538 describes applying dynamic effects on still pictures and US 2002/0105589 describes using effects filters for applying different effects on a picture. In the latter document a user can combine different filtering techniques as desired for providing new filtering effects.

US 2001/0034776 describes a computer system including a server supplying effects to different connected user terminals. A user terminal downloads an effect processing application from a server and uses the application when processing a picture. In the processing the user selects an effect from an effect server and receives the effect from the server for application on an image.

However none of the documents describes how a user can design and store his own effects to be applied on images.

There is thus a need for providing a way for users of local processing devices to be able to design and store their own effects to be used on images in order for users to put their own individual stamp on these effects.

### SUMMARY OF THE INVENTION

The present invention is thus directed towards solving the problem of providing the possibility to design own effects to be provided on images in a local processing device.

This is achieved by generating an effect and storing the effect as a file, such that it can be used for later application on images.

One object of the present invention is to provide a method enabling provision of the possibility to design and store own effects to be provided on images in a local processing device.

According to a first aspect of the present invention, the object is achieved by a method of providing storable image effects in a local processing device comprising the steps of:
generating an effect for application on digital images, and
storing the effect as an effects file, such that it can be used for later application on more than one image.

A second aspect of the present invention is directed to a method including the features of the first aspect, wherein the effect is stored in a defined standardised effects format.

A third aspect of the present invention is directed towards a method including the features of the second aspect, wherein the format is provided through an XML (Extensible Markup Language) file.

A fourth aspect of the present invention is directed towards a method including the features of the second aspect, wherein the step of storing includes storing the file with parameter settings made by a user.

A fifth aspect of the present invention is directed towards a method including the features of the first aspect, further including the step of transferring the effects file to another device.

A sixth aspect of the present invention is directed towards a method including the features of the fifth aspect, wherein the step of transferring is performed over a wireless medium.

A seventh aspect of the present invention is directed towards a method including the features of the first aspect, wherein the effect comprises a matrix of calculations to be performed on pixels of an image.

An eighth aspect of the present invention is directed towards a method including the features of the first aspect, further including the step of applying the effect on an image before storing and storing the effect as an effect file after detecting acceptance from a user of the device.

A ninth aspect of the present invention is directed towards a method including the features of the first aspect, wherein the step of generating an effect includes the step of retrieving a stored effects file and modifying the file with a new effect.

A tenth aspect of the present invention is directed towards a method including the features of the first aspect, wherein it is performed in a portable communication device.

Another object of the present invention is to provide a local processing device providing the possibility to design own effects to be provided on images in a local processing device.

According to an eleventh aspect of the present invention, this object is achieved by a local processing device for providing storable image effects comprising:
an image effects store, and
an image editor arranged to generate a new effect for application on digital images based on entries of a user and allowing storing of said effect as an effects file in the image effect store.

A twelfth aspect of the present invention is directed towards a device including the features of the eleventh aspect, wherein said effects are stored in a defined standardised effects format.

A thirteenth aspect of the present invention is directed towards a device including the features of the twelfth aspect, wherein the format is provided through an XML (Extensible Markup Language) file.

A fourteenth aspect of the present invention is directed towards a device including the features of the twelfth aspect, wherein the image editor is arranged to store the file with parameter settings made by a user.

A fifteenth aspect of the present invention is directed towards a device including the features of the eleventh aspect, further including at least one transmitting unit arranged to transmit effect files to at least one other device.

A sixteenth aspect of the present invention is directed towards a device including the features of the fifteenth aspect, wherein the transmitting unit is arranged to transmit effect files over a wireless interface.

A seventeenth aspect of the present invention is directed towards a device including the features of the eleventh aspect, wherein an effect comprises a matrix of calculations to be performed on images.

An eighteenth aspect of the present invention is directed towards a device including the features of the eleventh aspect, wherein the image editor is further arranged to apply an effect on an image before storing and storing the effect as an effects file after detecting acceptance from a user.

A nineteenth aspect of the present invention is directed towards a device including the features of the eleventh aspect, wherein the image editor when generating an effect is arranged to retrieve a stored effect file from the image effect store and apply a new effect to said file.

A twentieth aspect of the present invention is directed towards a device including the features of the eleventh aspect, wherein the device is a portable communication device.

A twenty-first aspect of the present invention is directed towards a device including the features of the twentieth aspect, wherein it is a cellular phone.

Yet another object is to provide an image editor for a local processing device providing the possibility to design own effects to be provided on images in the local processing device.

According to a twenty-second aspect of the present invention, this object is achieved by an image editor for providing storable image effects in a local processing device and arranged to:
generate a new effect for application on digital images based on entries of a user, and
allowing storing of said effect as an effects file in an image effect store.

Yet another object is to provide a computer program product for a local processing device providing the possibility to design own effects to be provided on images in the local processing device.

According to a twenty-third aspect of the present invention, this object is achieved by a computer program product, for enabling provision of storable image effects in the local processing device, comprising a computer readable medium having thereon:
computer program code means, to make the processing device execute, when said program is loaded in the processing device:
generate a new effect for application on digital images based on entries of a user, and
allowing storing of said effect as an effects file in an image effect store.

Yet another object is to provide a computer program element for a local processing device providing the possibility to design own effects to be provided on images in the local processing device.

According to a twenty-fourth aspect of the present invention, this object is achieved by a computer program element, for enabling provision of storable image effects in a local processing device, comprising a computer readable medium having thereon:
computer program code means, to make the processing device execute,
when said program is loaded in the processing device:
   generate a new effect for application on digital images based on entries of a user, and
   allowing storing of said effect as an effects file in an image effect store.

Yet another object of the present invention is to provide a signal, which provides the user of a local processing device to send effects to other devices.

According to a twenty-fifth aspect of the present invention, this object is achieved by a computer data signal embodied in a carrier wave comprising effect information relating to digital images in the form of an effects file in a defined standardised effects format generated by a local processing device, such that the effect information can be used for later application on digital images.

The invention has the following advantages. It allows the generation of personalised effects. The user does therefore not have to register with some central server or service in order to get new effects. A user can therefore independently create his own effects.

It should be emphasized that the term “comprises/comprising” when used in this specification is taken to specify the presence of stated features, integers, steps or components, but does not preclude the presence or addition of one or more other features, integers, steps, components or groups thereof.

### BRIEF DESCRIPTION OF THE DRAWINGS

The present invention will now be described in more detail In relation to the enclosed drawings, in which:

FIG. 1 shows a front view of a local processing device in the form of a cellular phone,

FIG. 2 shows a back view of the local processing device from FIG. 1,

FIG. 3 shows a block schematic of the relevant parts of the invention inside the phone of FIG. 1,

FIG. 4 shows a flowchart of a method according to the invention,

FIG. 5 shows a general outline of a file format for an effect made according to the invention,

FIG. 6 shows a signal format for transmitting an effects file from the local processing device according to the invention to another device, and

FIG. 7 shows a computer readable medium on which program code for performing the method according to the invention is provided.

### DETAILED DESCRIPTION OF EMBODIMENTS

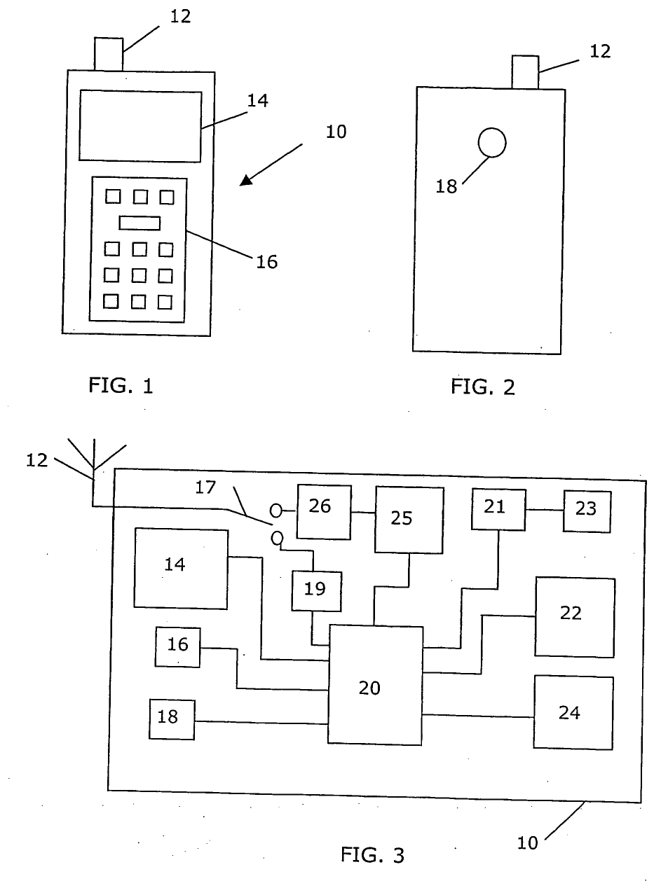

A local processing device 10 according to the invention is shown in a front view in FIG. 1. The device is local because it is not dependent on a central processing device for performing the invention. The device is preferably a portable communication device and in 35 the preferred embodiment the device is a cellular phone 10 having an antenna 12, a display 14, and a keypad 16. Apart from making and receiving telephone calls, the keypad 16 is used for entering information such as selection of functions and applications and responding to prompts and the display 14 is used for displaying functions, applications and prompts to a user of the phone. One such application is an image editor according to the invention. A cellular phone is just one example of a device in which the invention can be implemented. The invention can for instance also be used in a PDA (personal digital assistant), a palm top computer, a lap top computer, a smartphone and a digital camera or in a PC (personal Computer). In the case of a lap top computer communication can take place by using a so called PC card.

FIG. 2 shows a back view of the phone 10, where the lens of a camera 18 is provided. Thus the phone also includes a camera function.

FIG. 3 shows a block schematic of the different parts of the phone 10 relevant to the present invention. The display 14, the keypad 16 and a camera unit 18 are here shown as separate boxes connected to an image editor 20. The image editor 20 is furthermore connected to an image store 22 and to an image effects store 24 as well as to an MMS (Multimedia Messaging Service) application unit 25. The MMS application unit 25 is connected to a radio unit 26. The radio unit 26 is connected to the antenna 12 via a switch 17 in order to provide communication with other devices using a wireless network, which in the preferred embodiment is a GPRS network. A Bluetooth™ communication unit 19 is connected between the switch 17 and the image editor 20. A infrared control unit 21 is also connected to the image editor 20, which infrared control unit 21 is also connected to a an infrared communication interface 23 in the form of an infrared eye. In this way a user has the choice of communicating with other devices using the wireless network, Bluetooth™ or the infrared communication interface. It should be realised that other type of networks are also possible such as third generation wireless network, for instance wireless CDMA (Code Division Multiple Access) networks.

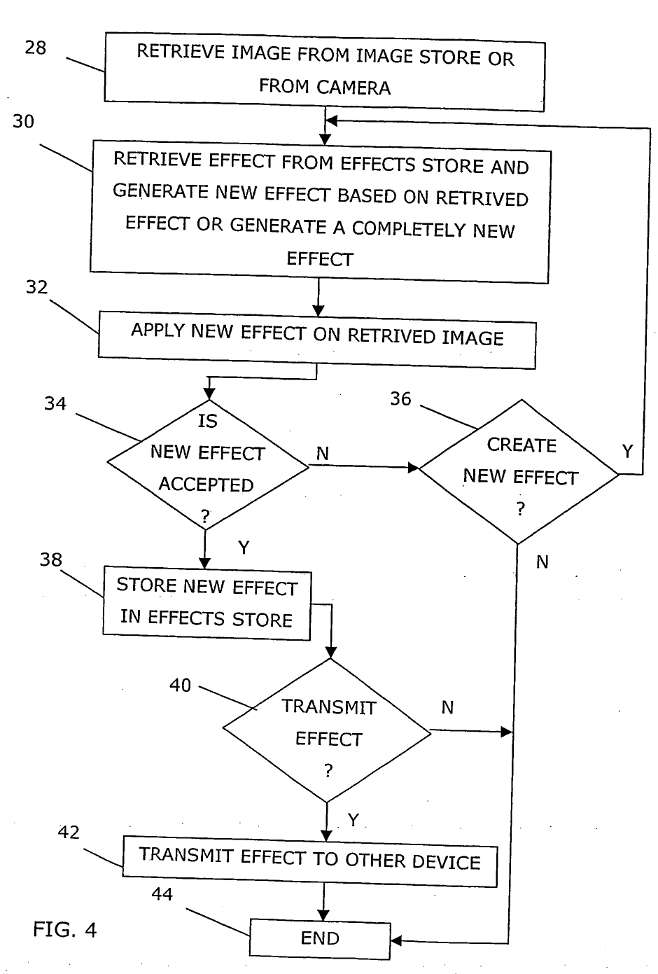

A first aspect of the present invention will now be explained in more detail with reference being made to FIG. 3 and 4, which latter figure shows a flow chart of a method according to the invention. A user can capture images by taking pictures using the camera unit 18. These images are then stored in the image store 22, either directly by the camera unit 18 or by the image editor 20 after receiving the picture from the camera unit 18. The picture can be in any known format such as JPEG or GIF. The method according to the invention starts with a user of the phone selecting an image editing application via a menu provided on the display 14 of the phone 10, after which selection he gets in contact with the image editor unit 20. Actual selection is then made using the keypad 16. In the image editor 20 a user can select to apply effects on images. The image editor has a number of pre-stored effects present in the image effects store 24. In the editor 20, the user can however also elect to make a new effect. When the user has selected to start making a new effect, he is first presented with the possibility to fetch an image from the image store 22. The method according to the invention therefore starts with the image editor 20 retrieving an image from the image store 22, step 28. As an alternative the input can be received directly from the camera. Thereafter the user can generate a new effect for the image. He can then select to retrieve an already stored effect or start generating a completely new effect. The image editor 20 thus retrieves an effect file from the effect store or generates a completely new effect based on inputs made by the user via the keypad 16, step 30. Effects that can be applied or generated are effects such as varying the brightness, colours used, or adding other effects like cutting the picture in different ways, inserting shadowing, overlaying other images like droplets or sunshine, sepia, negative art, pastel, slim, stretch, mosaic and provide the image in black & white. Effects can then be provided as clip arts provided on the screen. These effects can be combined in order to provide an individual new effect of the user. The user can also generate completely new effects based on a matrix of mathematical calculations applied on the pixels in the image, which can for Instance be used for providing different psychedelic effects. The matrix here has to be at least 3×3 pixels large. As the effect is generated it is applied on the retrieved image, step 32, for letting the user see the results of the effect applied on the image. Then the user is asked by the image editor 20 to accept or reject the effect, step 34. In case he accepts the effect, step 34, the effect is stored as an effects file in the effects store 24, step 38. Thereafter the user is asked if he wants to transmit the effect to another user, step 40. In case he wants that, step 40, the image editor 20 presents the user with a choice of communication using MMS, the infrared communication interface or Bluetooth™. If the user selects MMS, the Image editor 20 connects to the MMS application unit 25 for generating an MMS message and the MMS application unit 25 thereafter connects to the radio unit 26, which transmits the effect as an attachment in an MMS file sent to another user via the network, step 42. The user could here have decided to use Bluetooth™ instead, in which case the image editor 20 would connect to the Bluetooth™ communication unit 19, which would also use the antenna 12 for communicating with other units. In case the user would have chosen infrared communication, the image editor 20 would have connected to the infrared control unit 21, which would have been communicating with other devices using the infrared eye 23. After this the method is ended, step 44. In case the user did not want to transmit the effect, step 40, the method is ended directly, step 44. In case the effect was not accepted earlier, step 34, the user is asked if he wants to create a new effect, step 36. In case he does, the method goes back to step 30 and in case he does not the method is ended, step 44.

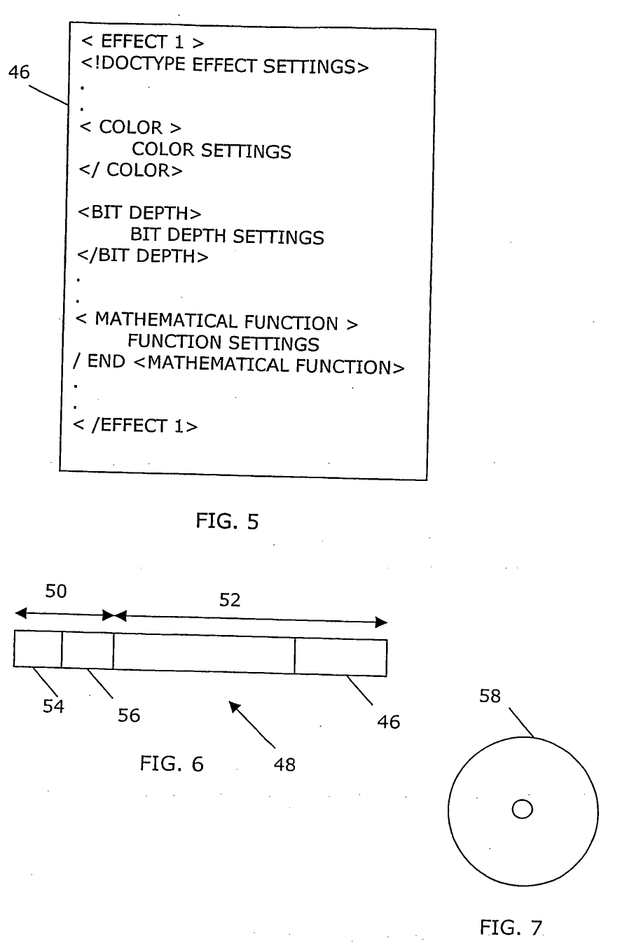

Now the generation of an effects file will be described in more detail. The effects generated by the user are stored as files of a known format in the effects store. This format is a standardised format recognised by other image editors. In the preferred embodiment, the file is an XML (Extensive Markup Language) file, of which FIG. 5 outlines such a file 46. First the effects file gets a name decided by the user and then the image editor inserts a piece of information about what type of file it is, which is an effects file. Each image editor receiving an effects file will recognise it as such upon reading this information. Thereafter the user gets to indicate some different parameters, which are entered. The parameters have been obtained by the user stating different settings, like colour, i.e. if the file is black and white, colour or grey scale and in that case also the bit depth of the colour coding, which can be 1, 2, 8, 16 and 24 bits. In FIG. 5 only a few of the possible different type of settings are indicated. These parameters could as an alternative have been read from the effects applied to the image retrieved from the image store. The XML file has a number of additional predefined fields, where different settings can be made for the individual setting of different effects, like some or all mentioned in the previous paragraph. The user can also define an own function for applying an effect, which function can be determined with the aid of the image editor. This function is then a matrix of mathematical calculations performed on each pixel of the image. The format is known to other devices having an image editor, such-that they can also apply the effect.

FIG. 6 shows an MMS message 48 used for sending the effects file to another device. In order to do this the message has a header field 50 and a payload field 52. In the header there is included a destination address 54 of a receiving device as well as the sending address 56 of the phone. It is of course possible to include more information in the header. The payload 52 then includes the XML-file 46 as an attachment. Also the payload can include other information such as text, sound files and image files as well as other types of attachments.

The image editor is preferably provided in the form of one or more processors with corresponding program memories containing suitable software code. The two stores are preferably provided in the form of memories. The image editor according to the invention can also be provided in a local computer. Therefore, the software for providing the method according to the invention can also be provided on a data carrier, which when loaded into the computer can perform the method according to the invention. The software can also be transferred to the phone from the PC or be directly loaded into the phone if it has a reader for the program data carrier. The data carrier is shown in FIG. 7 as an optical disc 58 of the CD ROM type. It should be realised that the program code can also be downloaded to the phone from another device for instance via the GPRS network described earlier. It is also possible that the extra functionality of the image editor can be provided in the form of an extra memory module, which can be inserted into the phone.

The present invention has many advantages. It allows the generation of personalised effects and the sending of these effects to other devices. The user does therefore not have to register with some central server or service in order to get new effects. A user can therefore independently create his own effects.

The present invention can be varied in many ways. The phone does not have to include the camera function, but the camera can be connected to the phone via a cord, a Bluetooth™ connection or be plugged into a system connector of the phone. Likewise the image editor does not have to be provided in the phone, but can be provided in such a camera communicating with a phone or other devices via any of the above described ways. The image editor according to the invention can also be provided in a computer like a PC and transfer image effects to different local processing devices or other PCs via for instance e-mail. The device according to the invention is furthermore not limited to using MMS for communicating effects, but can for instance communicate using WAP (Wireless Application Porotocol) instead. The device does in fact not have to use a wireless network at all in order to share effects with other devices, but can do this via Bluetooth™ links with other devices, as mentioned previously. The effects can be static effects but also include dynamic effects, like moving objects. An effect generated can furthermore be applied to only parts of an image. It is also possible to have more than one effect applied to an image, where perhaps some are-applied to different areas of the image. The effects file does not have to be an XML file, but can for instance also be an HTML-file or a WML-file. The image on which the effects are applied have in the previous section been described in relation to still pictures, but they can also be applied to moving images.

1. A method of providing storable image effects in a cellular phone comprising:
generating an effect for application on digital images based on entries of a user;
storing the effect as an effects file in a defined standardised image editor independent effects format; and
transferring the effects file to another device, such that it can be used for later application on more than one page.

2. A method according to claim 1, wherein the format is provided through an XML (Extensible Markup Language) file.

3. A method according to claim 1, wherein the step of storing the effect comprises storing the file with parameter settings made by a user.

4. A method according to claim 1, wherein transferring the effects is performed over a wireless medium.

5. A method according to claim 1, wherein the effect comprises a matrix of calculations to be performed on pixels of an image.

6. A method according to claim 1, further comprising applying the effect on an image before storing and storing the effect as the effects file after detecting acceptance from a user of the cellular phone.

7. A method according to any previous claim 1, wherein generating an effect comprises retrieving a stored effects file and modifying the stored effects file with a new effect.

8. A cellular phone for providing storable image effects comprising:
an image effects store;
an image editor arranged to generate a new effect for application on digital images based on entries of a user and allowing storing of said effect as an effects file in the image effects store in a defined standardised image editor independent effects format; and
at least one transmitting unit configured to transmit effect files to at least one other device.

9. A cellular phone according to claim 8, wherein the format is provided through an XML (Extensible Markup Language) file.

10. A cellular phone according to claim 8, wherein the image editor is arranged to store the file with parameter settings made by a user.

11. A cellular phone according to claim 8, wherein the at least one transmitting unit is configured to transmit effect files over a wireless interface.

12. A cellular phone according to claim 8, wherein the effect comprises a matrix of calculations to be performed on an image.

13. A cellular phone according to claim 8, wherein the image editor is further configured to apply the effect on an image before storing and storing the effect as an effects file after detecting acceptance from a user.

14. A cellular phone according to claim 8, wherein the image editor when generating the effect is arranged to retrieve a stored effects file from the image effect store and apply a new effect to said file.

15. An image editor for providing storable image effects in a cellular phone comprising:
a processor configured to generate a new effect for application on digital images based on entries of a user, to allow allowing storing of said effect as an effects files in an image effect store in a defined standardised image editor independent effects format, and to order a transmitting unit to transmit effect files to at least one other device.

16. A computer program product for enabling provision of storable image effects in a cellular phone comprising a computer readable medium having thereon:
computer program code configured to generate a new effect for application on digital images based on entries of a user;
computer program code configured to allow storing of said effect as an effects file in an image effect store in a defined standardisation image editor independent effects format; and
computer program code configured to order a transmitting unit to transmit effect files to at least one other device.

17. (canceled)

18. A computer data signal embodied in a carrier wave comprising effect information relating to digital images in the form of an effects file in a defined standardised image editor independent effects format generated by a cellular phone based on entries of a user, such that the effect information can be used for later application on digital images.
